(19) United States
(12) Patent Application Publication
(10) Pub. No.: US 2025/0066229 A1
(43) Pub. Date: Feb. 27, 2025

(54) REMINERALIZATION OF DESALINATED AND OF FRESH WATER BY DOSING OF A CALCIUM CARBONATE SOLUTION IN SOFT WATER

(71) Applicants: Martine POFFET, Berne (CH); Michael SKOVBY, Meilen (CH); Michael POHL, Villach (AT)

(72) Inventors: Martine POFFET, Berne (CH); Michael SKOVBY, Meilen (CH); Michael POHL, Villach (AT)

(21) Appl. No.: 18/826,656

(22) Filed: Sep. 6, 2024

Related U.S. Application Data
(63) Continuation of application No. 14/237,394, filed on Apr. 7, 2014, now abandoned.
(60) Provisional application No. 61/531,691, filed on Sep. 7, 2011.

(30) Foreign Application Priority Data
Aug. 31, 2011 (EP) 11179541.5

(51) Int. Cl. C02F 1/68; C02F 1/66; C02F 103/06; C02F 103/42

(52) U.S. Cl. CPC C02F 1/68; C02F 1/66; C02F 2103/06; C02F 2103/42; C02F 2209/05; C02F 2209/055; C02F 2209/06; C02F 2209/07; C02F 2209/10; C02F 2209/11; C02F 2209/24

(57) ABSTRACT

The present invention concerns a process for treating water and the use of calcium carbonate in such a process. In particular, the present invention is directed to a process for remineralization of water comprising the steps of providing feed water, providing an aqueous solution of calcium carbonate, wherein the aqueous solution of calcium carbonate comprises dissolved calcium carbonate and reaction species thereof, and combining the feed water and the aqueous calcium carbonate solution.

The invention relates to the field of water treatment, and more specifically to a process for remineralization of water and the use of calcium carbonate in such a process.

Drinking water has become scarce. Even in countries that are rich in water, not all sources and reservoirs are suitable for the production of drinking water, and many sources of today are threatened by a dramatic deterioration of the water quality. Initially feed water used for drinking purposes was mainly surface water and groundwater. However the treatment of seawater, brine, brackish waters, waste waters and contaminated effluent waters is gaining more and more importance for environmental and economic reasons.

In order to recover water from seawater or brackish water, for potable usages, several processes are known, which are of considerable importance for dry areas, coastal regions and sea islands, and such processes comprise distillation, electrolytic as well as osmotic or reverse osmotic processes. The water obtained by such processes is very soft and has a low pH value because of the lack of pH-buffering salts, and thus, tends to be highly reactive and, unless treated, it can create severe corrosion difficulties during its transport in conventional pipelines. Furthermore, untreated desalinated water cannot be used directly as a source of drinking water. To prevent the dissolution of undesirable substances in pipeline systems, to avoid the corrosion of water works such as pipes and valves and to make the water palatable, it is necessary to remineralize the water.

Conventional processes that are mainly used for the remineralization of water are lime dissolution by carbon dioxide and limestone bed filtration. Other, less common remineralization processes, comprise, e.g., the addition of hydrated lime and sodium carbonate, the addition of calcium sulfate and sodium bicarbonate, or the addition of calcium chloride and sodium bicarbonate.

The lime process involves treatment of lime solution with CO2 acidified water, wherein the following reaction is involved:

Ca(OH)2+2CO2→Ca2++2HCO3−

As can be gathered from the above reaction scheme, two equivalents of CO2 are necessary to convert one equivalent of Ca(OH)2 into Ca2+ and bicarbonate for remineralization. This method is dependent on the addition of two equivalents of CO2, in order to convert the alkaline hydroxide ions into the buffering species HCO3—. For the remineralization of water, a saturated calcium hydroxide solution, commonly named lime water, of 0.1-0.2 wt.-%, based on the total weight, is prepared from a lime milk (usually at most 5 wt.-%). Therefore, a saturator to produce the lime water must be used and large volumes of lime water are necessary to achieve the target level of remineralization. A further drawback of this method is that hydrated lime is corrosive and requires appropriate handling and specific equipment. Furthermore, a poorly controlled addition of hydrated lime to the soft water can lead to unwanted pH shifts due to the absence of buffering properties of lime.

The limestone bed filtration process comprises the step of passing the soft water through a bed of granular limestone dissolving the calcium carbonate in the water flow. Contacting limestone with CO2 acidified water mineralizes the water according to:

CaCO3+CO2+H2OΔCa2++2HCO3

Unlike the lime process, only one equivalent of CO2 is stoichiometrically necessary to convert one equivalent of CaCO3 into Ca2+ and bicarbonate for remineralization.

Moreover, limestone is not corrosive and due to the buffering properties of CaCO3 major pH shifts are prevented.

One additional advantage of the use of calcium carbonate compared to lime it its very low carbon dioxide footprint. In order to produce one tonne of calcium carbonate 75 kg of CO2 is emitted, whereas 750 kg of CO2 is emitted for the production of one tonne of lime. Therefore, the use of calcium carbonate instead of lime presents some environmental benefits.

The dissolution rate of granular calcium carbonate, however, is slow and filters are required for this process. This induces a sizeable footprint of these filters and large plant surfaces are required for the limestone bed filtration systems.

Methods for remineralization of water using lime milk or a slurry of lime are described in U.S. Pat. No. 7,374,694 and EP 0 520 826. U.S. Pat. No. 5,914,046 describes a method for reducing the acidity in effluent discharges using a pulsed limestone bed.

Thus, considering the drawbacks of the known processes for remineralization of water, it is an object of the present invention to provide an alternative or improved process for remineralization of water.

Another object of the present invention is to provide a process for remineralization of water that does not require a corrosive compound, and thus, avoids the danger of incrustation, eliminates the need for corrosion resistant equipment, and provides a safe environment for people working in the plant. It would also be desirable to provide a process that is environmental friendly and requires low amounts of carbon dioxide when compared to today's water remineralization with lime processes.

Another object of the present invention is to provide a process for remineralization of water, wherein the amount of minerals can be adjusted to the required values.

Another object of the present invention is to provide a process for remineralization using limestone that allows the use of smaller remineralization units, or to provide a remineralization process that allows the use of smaller volumes of the remineralization compound, for instance, in comparison with the lime process. It would also be desirable to provide a process that can be operated on smaller plant surfaces than the limestone bed filtration process.

While the Applicant knows as a solution the unpublished European Patent Application Number 10 172 771.7 describing a method for the remineralization of desalinated and fresh water by injecting a micronized calcium carbonate slurry, the foregoing and other objects are solved by the provision of a process for remineralization of water comprising the steps of (a) providing feed water, (b) providing an aqueous solution of calcium carbonate, wherein the solution of calcium carbonate comprises dissolved calcium carbonate and reaction species thereof, and (c) combining the feed water of step (a) and the aqueous solution of calcium carbonate of step (b).

According to another aspect of the present invention, a use of an aqueous solution of calcium carbonate comprising dissolved calcium carbonate and reaction species thereof for the remineralization of water is provided.

Advantageous embodiments of the present invention are defined in the corresponding sub-claims.

According to one embodiment the concentration of calcium carbonate in the solution is from 0.1 to 1 g/L, preferably from 0.3 to 0.8 g/L, and more preferably from 0.5 to 0.7 g/L, based on the total weight of the solution.

According to another embodiment the calcium carbonate used for the preparation of the aqueous solution of calcium carbonate in step b) has a weight median particle size d50 from 0.1 to 100 μm, from 0.5 to 50 μm, from 1 to 15 μm, preferably from 2 to 10 μm, most preferably 3 to 5 μm, or the calcium carbonate has a weight median particle size d50 from 1 to 50 μm, from 2 to 20 μm, preferably from 5 to 15 μm, and most preferably from 8 to 12 μm. The calcium carbonate particles may be obtained by techniques based on friction, e.g., milling or grinding either under wet or dry conditions. However, it is also possible to produce the calcium carbonate particles by any other suitable method, e.g., by precipitation, rapid expansion of supercritical solutions, spray drying, classification or fractionation of natural occurring sands or muds, filtration of water, sol-gel processes, spray reaction synthesis, flame synthesis, or liquid foam synthesis.

According to a preferred embodiment of the present invention the aqueous solution of calcium carbonate of step b) has been prepared by one of the following steps:
A) preparing an aqueous suspension of calcium carbonate in a first step, and introducing either: (i) a carbon dioxide generating compound, (ii) a carbon dioxide generating compound and an acid, or (iii) an acid to an aqueous suspension of calcium carbonate in a second step, or
B) introducing in a first step either: (i) a carbon dioxide generating compound, (ii) a carbon dioxide generating compound and an acid, or (iii) an acid in the water to be used for the preparation of the solution of calcium carbonate, and then introducing calcium carbonate, either in dry form or as a suspension in a second step in the water, or
C) introducing a suspension of calcium carbonate and either: (i) a carbon dioxide generating compound, (ii) a carbon dioxide generating compound and an acid, or (iii) an acid simultaneously.

For the purpose of the present invention, the term “carbon dioxide generating compound” encompasses gaseous carbon dioxide, liquid carbon dioxide, solid carbon dioxide, a gas containing carbon dioxide, i.e. a mixture of at least one gas and carbon dioxide, as well as compounds releasing carbon dioxide upon thermal or chemical treatment. Preferably the carbon dioxide generating compound is a gaseous mixture of carbon dioxide and other gases such as carbon dioxide containing flue gases exhausted from industrial processes like combustion processes or calcination processes or alike, or the carbon dioxide generating compound is gaseous carbon dioxide. When a gaseous mixture of carbon dioxide and other gases is used, then the carbon dioxide is present in the range of 8 to about 99% by volume, and preferably in the range of 10 to 25% by volume, for example 20% by volume.

The acid used in the present invention is preferably an acid selected from the group consisting of sulphuric acid, hydrochloric acid, sulphurous acid, phosphoric acid, and is preferably sulphuric acid or phosphoric acid.

According to still another embodiment the calcium carbonate has an HCl insoluble content from 0.02 to 2.5 wt.-%, 0.05 to 1.5 wt.-%, or 0.1 to 0.6 wt.-% based on the total weight of the calcium carbonate. According to still another embodiment the calcium carbonate is a ground calcium carbonate, modified calcium carbonate, or precipitated calcium carbonate, or mixtures thereof.

According to one embodiment the solution of step b) comprises further minerals containing magnesium, potassium or sodium, preferably magnesium carbonate, calcium magnesium carbonate, e.g. dolomitic limestone, calcareous dolomite or half burnt dolomite, magnesium oxide such as burnt dolomite, magnesium sulfate, potassium hydrogen carbonate, or sodium hydrogen carbonate.

According to another embodiment the solution of step b) is freshly prepared before the use in step b). According to still another embodiment the time period between the preparation of the solution of step b) and combining the feed water of step a) and the solution of step b) in step c) is less than 48 hours, less than 24 hours, less than 12 hours, less than 5 hours, less than 2 hours or less than 1 hour. According to still another embodiment the solution of step b) meets microbiological quality requirements specified by the national guidelines for drinking water.

According to one embodiment the obtained remineralized water has a calcium concentration as calcium carbonate from 15 to 200 mg/L, preferably from 30 to 150 mg/L, and most preferably from 100 to 125 mg/L, or from 15 to 100 mg/L, preferably from 20 to 80 mg/L, and most preferably from 40 to 60 mg/L.

According to another embodiment the obtained remineralized water has a magnesium concentration from 5 to 25 mg/L, preferably from 5 to 15 mg/L, and most preferred from 8 to 12 mg/l L. According to still another embodiment the remineralized water has a turbidity value of lower than 5.0 NTU, lower than 1.0 NTU, lower than 0.5 NTU, or lower than 0.3 NTU. According to still another embodiment the remineralized water has a Langelier Saturation Index from −1 to 2, preferably from −0.5 to 0.5, most preferred from −0.2 to 0.2. According to still another embodiment the remineralized water has a Silt Density Index SDI15 below 5, preferably below 4, and most preferred below 3. According to still another embodiment the remineralized water has a Membrane Fouling Index MFI0.45 below 4, preferably below 2.5, most preferred below 2.

According to one embodiment the feed water is desalinated seawater, brackish water or brine, treated wastewater or natural water such as ground water, surface water or rainfall.

According to one embodiment the remineralized water is blended with feed water. According to another embodiment the process further comprises a particle removal step.

According to one embodiment the process further comprises the steps of (d) measuring a parameter value of the remineralized water, wherein the parameter is selected from the group comprising alkalinity, total hardness, conductivity, calcium concentration, pH, CO2 concentration, total dissolved solids, and turbidity of the remineralized water, (e) comparing the measured parameter value with a predetermined parameter value, and (f) providing the amount of solution of calcium carbonate on the basis of the difference between the measured and the predetermined parameter value. According to another embodiment the predetermined parameter value is a pH value, wherein the pH value is from 5.5 to 9, preferably from 7 to 8.5.

According to one embodiment the micronized calcium carbonate is used for remineralization of water, wherein the remineralized water is selected from drinking water, recreation water such as water for swimming pools, industrial water for process applications, irrigation water, or water for aquifer or well recharge.

“Dissolved calcium carbonate and reaction species” in the meaning of the present invention is understood to encompass the following substances and ions: calcium carbonate (CaCO3), calcium ions (Ca2+), bicarbonate ions (HCO3−), carbonate ions (CO3 2−), carbonic acid (H2CO3) as well as dissolved CO2, depending on the amount of CO2 dissolved at equilibrium conditions.

The term “alkalinity (TAC)” as used in the present invention is a measure of the ability of a solution to neutralize acids to the equivalence point of carbonate or bicarbonate. The alkalinity is equal to the stoichiometric sum of the bases in solution and is specified in mg/L as CaCO3. The alkalinity may be measured with a titrator.

For the purpose of the present invention the term “calcium concentration” refers to the total calcium content in the solution and is specified in mg/l as Ca2+ or as CaCO3. The concentration may be measured with a titrator.

“Conductivity” in the meaning of the present invention is used as an indicator of how salt-free, ion-free, or impurity-free the measured water is; the purer the water, the lower the conductivity. The conductivity can be measured with a conductivity meter and is specified in S/m.

“Ground calcium carbonate (GCC)” in the meaning of the present invention is a calcium carbonate obtained from natural sources including marble, chalk or limestone or dolomite. Calcite is a carbonate mineral and the most stable polymorph of calcium carbonate. The other polymorphs of calcium carbonate are the minerals aragonite and vaterite. Aragonite will change to calcite at 380-470° C., and vaterite is even less stable. Ground calcium carbonate processed through a treatment such as grinding, screening and/or fractionizing by wet and/or dry, for example, by a cyclone. It is known to the skilled person that ground calcium carbonate can inherently contain a defined concentration of magnesium, such as it is the case for dolomitic limestone.

The term “Langelier Saturation Index (LSI)” as used in the present invention describes the tendency of an aqueous liquid to be scale-forming or corrosive, with a positive LSI indicating scale-forming tendencies and a negative LSI indicating a corrosive character. A balanced Langelier Saturation Index, i.e. LSI=0, therefore means that the aqueous liquid is in chemical balance. The LSI is calculated as follows:

$$LSI = pH - pHs ,$$

wherein pH is the actual pH value of the aqueous liquid and pHs is the pH value of the aqueous liquid at CaCO3 saturation. The pHs can be estimated as follows:

$$pHs = ( 9.3 + A + B ) - ( C + D ) ,$$

wherein A is the numerical value indicator of total dissolved solids (TDS) present in the aqueous liquid, B is the numerical value indicator of temperature of the aqueous liquid in K, C is the numerical value indicator of the calcium concentration of the aqueous liquid in mg/l of CaCO3, and D is the numerical value indicator of alkalinity of the aqueous liquid in mg/l of CaCO3. The parameters A to D are determined using the following equations:

$$A = ( log 10 ( TDS ) - 1 ) / 10 ,$$

$$B = - 13.12 \times log 10 ( T + 273 ) + 34.55 ,$$

$$C = log 10 [ Ca 2 + ] - 0 \text{.4} ,$$

$$D = log 10 ( TAC ) ,$$

wherein TDS are the total dissolved solids in mg/l, T is the temperature in ° C., [Ca2+ is the calcium concentration of the aqueous liquid in mg/l of CaCO3, and TAC is the alkalinity of the aqueous liquid in mg/L of CaCO3.

The term “Silt Density Index (SDI)” as used in the present invention refers to the quantity of particulate matter in water and correlates with the fouling tendency of reverse osmosis or nanofiltration systems. The SDI can be calculated, e.g., from the rate of plugging of a 0.45 μm membrane filter when water is passed through at a constant applied water pressure of 208.6 kPa. The SDI15 value is calculated from the rate of plugging of a 0.45 μm membrane filter when water is passed through at a constant applied water pressure of 208.6 kPa during 15 min. Typically, spiral wound reverse osmosis systems will need an SDI less than 5, and hollow fiber reverse osmosis systems will need an SDI less than 3.

The term “Modified Fouling Index (MFI)” as used in the present invention refers to the concentration of suspended matter and is a more accurate index than the SDI for predicting the tendency of a water to foul reverse osmosis or nanofiltration membranes. The method that can be used for determining the MFI may be the same as for the SDI except that the volume is recorded every 30 seconds over a 15 minute filtration period. The MFI can be obtained graphically as the slope of the straight part of the curve when t/V is plotted against V (t is the time in seconds to collect a volume of V in liters). An MFI value of <1 corresponds to an SDI value of about <3 and can be considered as sufficiently low to control colloidal and particulate fouling.

In case an ultrafiltration (UF) membrane is used for MFI measurements, the index is called MFI-UF in contrast to the MFI0.45 where a 0.45 μm membrane filter is used.

For the purpose of the present invention, the term “micronized” refers to a particle size in the micrometer range, e.g., a particle size from 0.1 to 100 μm. The micronized particles may be obtained by techniques based on friction, e.g., milling or grinding either under wet or dry conditions. However, it is also possible to produce the micronized particles by any other suitable method, e.g., by precipitation, rapid expansion of supercritical solutions, spray drying, classification or fractionation of natural occurring sands or muds, filtration of water, sol-gel processes, spray reaction synthesis, flame synthesis, or liquid foam synthesis.

Throughout the present document, the “particle size” of a calcium carbonate product is described by its distribution of particle sizes. The value dx represents the diameter relative to which x% by weight of the particles have diameters less than dx. This means that the d20 value is the particle size at which 20 wt.-% of all particles are smaller, and the d75 value is the particle size at which 75 wt.-% of all particles are smaller. The d50 value is thus the weight median particle size, i.e. 50 wt.-% of all grains are bigger or smaller than this particle size. For the purpose of the present invention the particle size is specified as weight median particle size d50 unless indicated otherwise. For determining the weight median particle size d50 value for particles having a d50 greater than 0.5 μm, a Sedigraph 5100 device from the company Micromeritics, USA can be used.

“Precipitated calcium carbonate (PCC)” in the meaning of the present invention is a synthesized material, generally obtained by precipitation following the reaction of carbon dioxide and lime in an aqueous environment or by precipitation of a calcium and carbonate source in water or by precipitation of calcium and carbonate ions, for example CaCl2 and Na2CO3, out of solution. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like forms.

“Modified calcium carbonate” in the meaning of the present invention is a surface-reacted natural calcium carbonate that is obtained by a process where natural calcium carbonate is reacted with one more acids having a pKa at 25° C. of 2.5 or less and with gaseous CO2 formed in situ and/or coming from an external supply, and optionally in the presence of at least one aluminum silicate and/or at least one synthetic silica and/or at least one calcium silicate and/or at least one silicate of a monovalent salt such as sodium silicate and/or potassium silicate and/or lithium silicate, and/or at least one aluminum hydroxide and/or at least one sodium and/or potassium silicate. Further details about the preparation of the surface-reacted natural calcium carbonate are disclosed in WO 00/39222 and US 2004/0020410 A1, the contents of these references herewith being included in the present patent application.

For the purpose of the present invention, a “slurry” comprises insoluble solids and water and optionally further additives and usually contains large amounts of solids and, thus, is more viscous and generally of higher density than the liquid from which it is formed.

The term “remineralization” as used in the present invention refers to the restoration of minerals in water not containing minerals at all, or in an insufficient amount, in order to obtain a water that is palatable. A remineralization can be achieved by adding at least calcium carbonate to the water to be treated. Optionally, e.g., for health-related benefits to ensure the appropriate intake of some essential minerals and trace elements, further substances may be mixed into or with the calcium carbonate and then added to the water during the remineralization process. According to the national guidelines on human health and drinking water quality, the remineralized product may comprise additional minerals containing magnesium, potassium or sodium, e.g., magnesium carbonate, magnesium sulfate, potassium hydrogen carbonate, sodium hydrogen carbonate or other minerals containing essential trace elements.

For the purpose of the present invention, a solution of calcium carbonate means a clear solution of calcium carbonate in a solvent, where all or nearly all of the CaCO3 has been dissolved in the solvent so as to form a visually clear solution. The solvent is preferably water.

The term “total dissolved solids (TDS)” as used in the present invention is a measure of the combined content of all inorganic and organic substances contained in a liquid in molecular, ionized or micro-granular (colloidal sol) suspended form. Generally the operational definition is that the solids must be small enough to survive filtration through a sieve having an aperture size of two micrometers. The total dissolved solids can be estimated with a conductivity meter and are specified in mg/L.

“Turbidity” in the meaning of the present invention describes the cloudiness or haziness of a fluid caused by individual particles (suspended solids) that are generally invisible to the naked eye. The measurement of turbidity is a key test of water quality and can be carried out with a nephelometer. The units of turbidity from a calibrated nephelometer as used in the present invention are specified as Nephelometric Turbidity Units (NTU).

The inventive process for remineralization of water comprises the steps of (a) providing feed water, (b) providing an aqueous solution of calcium carbonate, wherein the aqueous solution of calcium carbonate comprises dissolved calcium carbonate and reaction species thereof, and (c) combining the feed water of step a) and the aqueous calcium carbonate solution of step b).

The feed water to be used in the inventive process can be derived from various sources. The feed water preferably treated by the process of the present invention is desalinated seawater, brackish water or brine, treated wastewater or natural water such as ground water, surface water or rainfall.

According to one embodiment of the present invention, the feed water can be pretreated. A pretreatment may be necessary, e.g., in case the feed water is derived from surface water, groundwater or rainwater. For example, to achieve the drinking water guidelines the water needs to be treated through the use of chemical or physical techniques in order to remove pollutants such as organics and undesirable minerals. For example, ozonation can be used as a first pretreatment step, followed then by coagulation, flocculation, or decantation as a second treatment step. For example, iron (III) salts such as FeClSO4 or FeCl3, or aluminum salts such as AlCl3, Al2(SO4)3 or polyaluminium may used as flocculation agents. The flocculated materials can be removed from the feed water, e.g, by means of sand filters or multi-layered filters. Further water purification processes that may be used to pretreat the feed water are described, e.g., in EP 1 975 310, EP 1 982 759, EP 1 974 807, or EP 1 974 806.

According to another exemplary embodiment of the present invention, sea water or brackish water is firstly pumped out of the sea by open ocean intakes or subsurface intakes such as wells, and then it undergoes physical pretreatments such as screening, sedimendation or sand removal processes. Depending on the required water quality, additional treatment steps such as coagulation and flocculation may be necessary in order to reduce potential fouling on the membranes. The pretreated seawater or brackish water may then be distilled, e.g., using multiple stage flash, multiple effect distillation, or membrane filtration such as ultrafiltration or reverse osmosis, to remove the remaining particulates and dissolved substances.

The aqueous solution of calcium carbonate of step b) has preferably been prepared by one of the following steps:
A) preparing an aqueous suspension of calcium carbonate in a first step, and introducing either: (i) a carbon dioxide generating compound, (ii) a carbon dioxide generating compound and an acid, or (iii) an acid to an aqueous suspension of calcium carbonate in a second step, or
B) introducing in a first step either: (i) a carbon dioxide generating compound, (ii) a carbon dioxide generating compound and an acid, or (iii) an acid in the water to be used for the preparation of the solution of calcium carbonate, and then introducing calcium carbonate, either in dry form or as a suspension in a second step in the water, or
C) introducing a suspension of calcium carbonate and either: (i) a carbon dioxide generating compound, (ii) a carbon dioxide generating compound and an acid, or (iii) an acid simultaneously.

The carbon dioxide generating compound used is selected from among gaseous carbon dioxide, liquid carbon dioxide, solid carbon dioxide and a gas containing carbon dioxide, and preferably the carbon dioxide generating compound is a gaseous mixture of carbon dioxide and other gases such as carbon dioxide containing flue gases exhausted from industrial processes like combustion processes or calcination processes or alike, or the carbon dioxide generating compound is gaseous carbon dioxide. When a gaseous mixture of carbon dioxide and other gases is used, then the carbon dioxide is present in the range of 8 to about 99% by volume, and preferably in the range of 10 to 25% by volume, for example 20% by volume.

The gaseous carbon dioxide may be obtained from a storage tank, in which it is held in the liquid phase. Depending on the consumption rate of carbon dioxide and the environment either cryogenic or conventionally insulated tanks may be used. The conversion of the liquid carbon dioxide into the gaseous carbon dioxide can be done using an air heated vaporizer, or an electrical or steam based vaporizing system. If necessary, the pressure of the gaseous carbon dioxide can be reduced prior to the injection step, e.g., by using a pressure reducing valve.

The gaseous carbon dioxide can be injected into a stream of feed water at a controlled rate, forming a dispersion of carbon dioxide bubbles in the stream and allowing the bubbles to dissolve therein. For example, the dissolution of carbon dioxide in the feed water can be facilitated by providing the feed water stream at a flow rate of 40-60 mg/l according to the starting CO2 concentration in the permeate/distillate, the final target pH value (excess CO2) and final target calcium concentration (added CaCO3).

According to an exemplary embodiment, the carbon dioxide is introduced into the water used for the preparation of the solution of calcium carbonate at a turbulent region of the water, wherein the turbulence can be created, e.g., by a restriction in the pipeline. For example, the carbon dioxide may be introduced into the throat of a venturi disposed in the pipeline. The narrowing of the cross sectional area of the pipeline at the throat of the venturi creates turbulent flow of sufficient energy to break up the carbon dioxide into relatively small bubbles and thereby facilitate its dissolution. According to one embodiment, the carbon dioxide is introduced under pressure into the stream of water. According to another embodiment of the present invention, the dissolution of carbon dioxide in the water used for the preparation of the solution of calcium carbonate is facilitated by a static mixer.

A flow control valve or other means may be used to control the rate of flow of carbon dioxide into the water used for the preparation of the calcium carbonate solution. For example, a CO2 dosing block and a CO2 in-line measuring device may be used to control the rate of the CO2 flow. According to one exemplary embodiment of the invention, the CO2 is injected using a combined unit comprising a CO2 dosing unit, a static mixer and an in-line CO2 measuring device.

The carbon dioxide acidifies the feed water by forming carbonic acid. The amount of carbon dioxide that is injected into the feed water will depend on the amount of carbon dioxide that is already present in the feed water. The amount of carbon dioxide that is already present in feed water, in turn, will depend, e.g., on the treatment up-stream of the feed water. Feed water, for example, that has been desalinated by flash evaporation will contain another amount of carbon dioxide, and thus another pH, than feed water that has been desalinated by reverse osmosis. Feed water, for example, that has been desalinated by reverse osmosis may have a pH of about 5.3 and an amount of CO2 of about 1.5 mg/l.

The remineralization of the feed water is induced by injecting the solution of calcium carbonate comprising the dissolved calcium carbonate and reaction species thereof into the feed water.

The solution of calcium carbonate that is injected into the feed water comprises dissolved calcium carbonate. According to one embodiment the concentration of calcium carbonate in the solution is from 15 to 200 mg/L, preferably from 30 to 150 mg/L, and most preferably from 100 to 125 mg/L, or from 15 to 100 mg/L, preferably from 20 to 80 mg/L, and most preferably from 40 to 60 mg/L.

The calcium carbonate used for the preparation of the aqueous solution of calcium carbonate of step b) possesses a weight media particle size d50 in the micrometer range. According to one embodiment, the micronized calcium has a weight median particle size d50 from 0.1 to 100 μm, from 0.5 to 50 μm, from 1 to 15 μm, preferably from 2 to 10 μm, most preferably from 3 to 5 μm, or the calcium carbonate has a weight median particle size d50 from 1 to 50 μm, from 2 to 20 μm, preferably from 5 to 15 μm, and most preferably from 8 to 12 μm.

Examples for suitable calcium carbonates are ground calcium carbonate, modified calcium carbonate or precipitated calcium carbonate, or a mixture thereof. A natural ground calcium carbonate (GCC) may be derived from, e.g., one or more of marble, limestone, chalk, and/or dolomite. A precipitated calcium carbonate (PCC) may feature, e.g., one or more of aragonitic, vateritic and/or calcitic mineralogical crystal forms. Aragonite is commonly in the acicular form, whereas vaterite belongs to the hexagonal crystal system. Calcite can form scalenohedral, prismatic, spheral, and rhombohedral forms. A modified calcium carbonate may feature a natural ground or precipitated calcium carbonate with a surface and/or internal structure modification, e.g., the calcium carbonate may be treated or coated with a hydrophobising surface treatment agent such as, e.g. an aliphatic carboxylic acid or a siloxane. Calcium carbonate may be treated or coated to become cationic or anionic with, for example, a polyacrylate or polydadmac.

According to one embodiment of the present invention, the calcium carbonate is a ground calcium carbonate (GCC). According to a preferred embodiment, the calcium carbonate is a ground calcium carbonate having a particle size from 3 to 5 μm.

According to another embodiment of the present invention, the calcium carbonate comprises an HCl insoluble content from 0.02 to 2.5 wt.-%, 0.05 to 1.5 wt.-%, or 0.1 to 0.6 wt.-%, based on the total weight of the calcium carbonate. Preferably, the HCl insoluble content of the calcium carbonate does not exceed 0.6 wt.-%, based on the total weight of the calcium carbonate. The HCl insoluble content may be, e.g., minerals such as quartz, silicate or mica.

In addition to the calcium carbonate, the solution of calcium carbonate can comprise further micronized minerals. According to one embodiment, the solution of calcium carbonate can comprise micronized magnesium carbonate, calcium magnesium carbonate, e.g. dolomitic limestone, calcareous dolomite or half burnt dolomite, magnesium oxide such as burnt dolomite, magnesium sulfate, potassium hydrogen carbonate, sodium hydrogen carbonate or other minerals containing essential trace elements.

According to one embodiment of the present invention, the solution of calcium carbonate is freshly prepared before it is combined with the feed water. The on-site preparation of the solution of calcium carbonate may be preferred. The reason is that when the solution of calcium carbonate is not prepared on-site and/or freshly the addition of further agents such as stabilizers or biocides to the solution of calcium carbonate may be required for stabilizing reasons. However, such agents may be unwanted compounds in the remineralized water, e.g. for toxic reasons or may inhibit the formation of freely available Ca2+ ions. According to one preferred embodiment of the present invention, the time period between the preparation of the solution of calcium carbonate and the injection of the solution of calcium carbonate is short enough to avoid bacterial growth in the solution of calcium carbonate. According to one exemplary embodiment, the time period between the preparation of the solution of calcium carbonate and the injection of the solution of calcium carbonate is less than 48 hours, less than 24 hours, less than 12 hours, less than 5 hours, less than 2 hours or less than 1 hour. According to another embodiment of the present invention, the injected solution meets the microbiological quality requirements specified by the national guidelines for drinking water.

The solution of calcium carbonate can be prepared, for example, using a mixer such as a mechanical stirrer for solutions, or a specific powder-liquid mixing device for more concentrated solutions of calcium carbonate, or a loop reactor. According to one embodiment of the present invention, the solution of calcium carbonate is prepared using a mixing machine, wherein the mixing machine enables simultaneous mixing and dosing of the solution of calcium carbonate.

The water used to prepare the solution can, for example, be distilled water, feed water or industrial water. According to one preferred embodiment of the invention, the water used to prepare the solution is feed water, e.g. permeate or distillate obtained from a desalination process. According to one exemplary embodiment, the water used to prepare the solution of calcium carbonate is acidified carbon dioxide. Without being bound to any theory, it is believed that such a CO2-pretreatment of the water used to prepare the solution of calcium carbonate increases the dissolution of calcium carbonate in the water, and thus decreases the reaction time.

According to one embodiment the solution of calcium carbonate comprising dissolved calcium carbonate is injected directly into a stream of feed water. For example, the solution of calcium carbonate can be injected into the feed water stream at a controlled rate by means of a pump communicating with a storage vessel for the solution. Preferably, the solution of calcium carbonate may be injected into the feed water stream at a rate of 1 to 200 l/m3 of feed water, depending on the solution concentration and the final concentration in the remineralized water. According to another embodiment the solution of calcium carbonate comprising dissolved calcium carbonate is mixed with the feed water in a reaction chamber, e.g., using a mixer such as a mechanical mixer. According to still another embodiment the solution of calcium carbonate is injected in a tank receiving the entire flow of feed water.

According to one embodiment of the present invention, only a part of the feed water is remineralized by injecting the solution of calcium carbonate, and subsequently, the remineralized water is blended with untreated feed water. Optionally, only a part of the feed water is remineralized to a high calcium carbonate concentration compared to the final target value, and, subsequently, the remineralized water is blended with untreated feed water.

According to another embodiment the concentrated solution of calcium carbonate or part of the concentrated solution of calcium carbonate is filtered, e.g., by ultra filtration, to further reduce the turbidity level of the remineralized water.

For the purpose of the present invention, the term “concentrated solution of calcium carbonate” is to be understood as a solution of calcium carbonate that contains the maximum possible amount of dissolved calcium carbonate in the respective solvent. This highest possible amount of dissolved calcium carbonate can be determined by methods known to the person skilled in the art, such as the measurement of the conductivity, or the measurement of the hardness by titration.

The quality of the remineralized water can, for example, be assessed by the Langelier Saturation Index (LSI). According to one embodiment, the remineralized water has a Langelier Saturation Index from −1 to 2, preferably from −0.5 to 0.5, most preferred from −0.2 to 0.2. According to another embodiment, the remineralized water has a Silt Density Index SDI15 below 5, preferably below 4, and most preferred below 3. According to still another embodiment the remineralized water has a Membrane Fouling Index MFI0.45 below 4, preferably below 2.5, most preferred below 2. The assessment can be done, e.g., by measuring the pH of the treated feed water continuously. Depending on the remineralization system, the pH of the treated pH can be measured, e.g., in a stream of treated water, in a reaction chamber, wherein the solution of calcium carbonate and the feed water is mixed, or in a storage tank for the remineralized water. According to one embodiment of the present invention, the pH is measured 30 min, 20 min, 10 min, 5 min or 2 min after the remineralization step. The measurement of the pH value may be done at room temperature, i.e. at about 20° C.

According to one exemplary embodiment of the invention, the amount of the injected solution of calcium carbonate is controlled by detecting the pH value of the treated feed water. Alternatively or additionally, the amount of the injected solution of calcium carbonate is controlled by detecting parameters such as alkalinity, total hardness, conductivity, calcium concentration, CO2 concentration, total dissolved solids, or turbidity. According to one embodiment, the process of the present invention further comprises the steps of (d) measuring a parameter value of the remineralized water, wherein the parameter is selected from the group comprising alkalinity, total hardness, conductivity, calcium concentration, pH, CO2 concentration, total dissolved solids, or turbidity of the remineralized water, (e) comparing the measured parameter value with a predetermined parameter value, and (f) providing the amount of injected solution of calcium carbonate on the basis of the difference between the measured and the predetermined parameter value.

According to one embodiment, the predetermined parameter value is a pH value, wherein the pH value is from 5.5 to 9, preferably from 7 to 8.5.

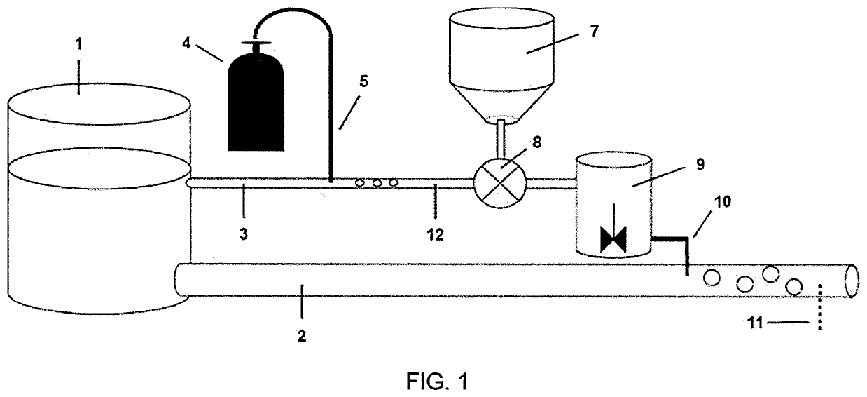

FIG. 1 shows a scheme of an apparatus that can be used for operating the inventive method. In this embodiment, the feed water flows from a reservoir 1) into a pipeline 2). A further pipe 12) is arranged between the reservoir 1) and a storage tank 9). The pipe 12) has a gas inlet 5) through which carbon dioxide from a carbon dioxide source 4) can be injected into the feed water to prepare CO2-acidified water in a first step. A mixer 8) is connected to the pipe 12) downstream the reservoir 1). In the mixer 8), the solution of calcium carbonate is prepared on-site by mixing water that is obtained from the reservoir 1) via pipe 12) and the calcium carbonate obtained from a storage container 7). A storage tank 9) can be in connection with the pipe 12). When it is present, it is provided after the mixer 8) in order to store the solution of calcium carbonate before its introduction into the feed water stream. A inlet 10) is located downstream of the reservoir 1) in pipeline 2) through which the solution of calcium carbonate comprising dissolved calcium carbonate coming from the mixer 8) is injected into the feed water stream via the storage tank 9), when present. The pH of the remineralized water can be measured downstream of the slurry inlet 10) on a sample point 11). According to one embodiment the flow rate of the feed water is 20 000 and 500 000 m3 per day.

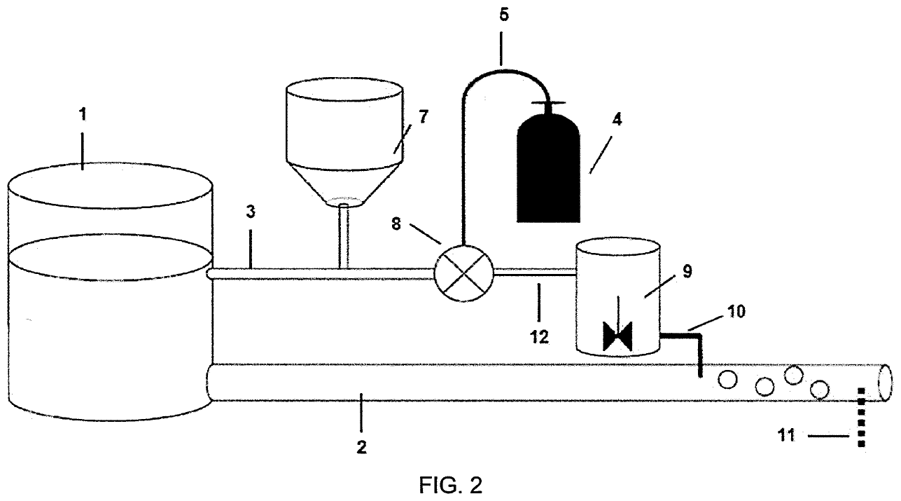

FIG. 2 shows another embodiment of the present invention. In this embodiment, the aqueous suspension of calcium carbonate is prepared in a first step by introducing the calcium carbonate obtained from a storage container 7) in the feed water that is obtained from reservoir 1) and flows through pipe 12). In a second step, the carbon dioxide from a carbon dioxide source 4) is combined with the water of pipe 12) that already contains the suspension of calcium carbonate in the mixer 8). Then, the water containing the suspension of calcium carbonate and the carbon dioxide are mixed in order to obtain the solution of calcium carbonate comprising dissolved calcium carbonate. Through inlet 10) located in pipeline 2) downstream of the reservoir 1), the solution of calcium carbonate comprising dissolved calcium carbonate coming from the mixer 8) is then injected into the feed water stream. The pH of the remineralized water can be measured downstream of the slurry inlet 10) on a sample point 11). According to one embodiment the flow rate of the feed water is 20 000 and 500 000 m3 per day.

It is noted that the storage tank 9) is an optional feature for carrying out the process of the present invention. In other words, the storage tank 9) has not to be present in embodiments of the present invention. In this case, the solution of calcium carbonate is directly injected from the mixer 8) into the feed water stream of pipeline 2) through inlet 10).

The inventive process may be used to produce drinking water, recreation water such as water for swimming pools, industrial water for process applications, irrigation water, or water for aquifer or well recharge.

According to one embodiment, the carbon dioxide and calcium carbonate concentrations in the remineralized water meet the required values for drinking water quality, which are set by national guidelines. According to one embodiment the remineralized water obtained by the inventive process has a calcium concentration from 15 to 200 mg/L as CaCO3, preferably from 30 to 150 mg/L, and most preferred from 40 to 60 mg/L, or preferably from 50 to 150 mg/L as CaCO3, and most preferred from 100 to 125 mg/L as CaCO3. In case the solution comprises a further magnesium salt such as magnesium carbonate, or magnesium sulfate, the remineralized water obtained by the inventive process may have a magnesium concentration from 5 to 25 mg/L, preferably from 5 to 15 mg/L, and most preferred from 8 to 12 mg/L.

According to one embodiment of the present invention the remineralized water has a turbidity of lower than 5.0 NTU, lower than 1.0 NTU, lower than 0.5 NTU, or lower than 0.3 NTU.

According to one exemplary embodiment of the present invention the remineralized water has a LSI from −0.2 to +0.2, a calcium concentration from 15 to 200 mg/L, a magnesium concentration from 5 to 25 mg/L, an alkalinity between 100 and 200 mg/L as CaCO3, a pH between 7 and 8.5, and a turbidity of lower than 0.5 NTU.

According to one embodiment of the present invention a step of particle removal is carried out after mineralization, e.g., to reduce the turbidity level of the remineralized water. According to one embodiment a sedimentation step is carried out. For example, the feed water and/or remineralized water may be piped into a clarifier or storage tank to further reduce the turbidity level of the water. According to another embodiment the particles may be removed by decantation. Alternatively, at least a part of the feed water and/or remineralized water may be filtered, e.g., by ultra filtration, to further reduce the turbidity level of the water.

### EXAMPLES

### Measurement Methods

### BET Specific Surface Area

The BET specific surface area (also designated as SSA) was determined according to ISO 9277 using a Tristar II 3020 sold by the company MICROMERITICS™.

Particle size distribution (mass % particles with a diameter≤X μm) and weight median particle diameter (d50) of particulate material (d50 (μm))

### Sedigraph™5100

The weight median particle diameter and the particle diameter mass distribution of a particulate material were determined via the sedimentation method, i.e. an analysis of sedimentation behavior in a gravimetric field. The measurement is made with a Sedigraph™5100 sold by the company MICROMERITICS™

The method and the instrument are known to the skilled person and are commonly used to determine particle size of fillers and pigments. Samples were prepared by adding an amount of the product corresponding to 4 g dry PCC to 60 ml of an aqueous solution of 0.1% by weight of Na4P2O7. The samples were dispersed for 3 minutes using a high speed stirrer (Polytron PT 3000/3100 at 15,000 rpm). Then it was submitted to ultrasound using an ultrasonic bath for 15 minutes and thereafter added to the mixing chamber of the Sedigraph.

### Weight Solids (% by Weight) of a Material in Suspension

The weight solids (also called solids content of a material) was determined by dividing the weight of the solid material by the total weight of the aqueous suspension.

The weight of the solid material was determined by weighing the solid material obtained by evaporating the aqueous phase of the suspension and drying the obtained material to a constant weight.

The following examples present the preparation of different solutions of calcium carbonate at various concentrations, which were prepared from a range of calcium carbonate products according to their physical and chemical properties, e.g. carbonate rocks, mean particle size, insoluble content, and so on.

The following Table 1 summarizes the different calcium carbonate products used during the remineralization tests.

TABLE 1

| Samples^{[1]} | Calcium carbonate rock | d50 (μm) | HCl insoluble (%) |
|---|---|---|---|
| A | Limestone | 3.0 | 0.1 |
| B | Marble | 1.8 | 1.5 |
| C | Marble | 2.8 | 1.5 |
| D | Marble | 3.3 | 2.0 |
| E | Marble | 8.0 | 2.0 |
| F | Marble | 4.4 | 0.2 |
| G | Marble | 10.8 | 0.2 |
| H | PCC | 0.6 | 0.1 |

^{[1]}It has to be noted that all of the above listed calcium carbonates are commercially available from Omya, Switzerland.

### A. Lab Examples

Three samples were tested for this study, sample A is a limestone calcium carbonate from France and samples B and C are a marble calcium carbonate supplied from the same plant in Australia, but with different weight median particle size.

Table 2 summaries the different products used during the remineralization tests performed at lab-scale.

TABLE 2

| Sample | d50 (μm) | CaCO3 (%) | HCl insoluble (%) |
|---|---|---|---|
| A | 3.0 | 99.3 | 0.1 |
| B | 1.8 | 95.0 | 1.5 |
| C | 2.8 | 95.0 | 1.5 |

The water used for these remineralization tests was water that was obtained by reverse osmosis (RO) and that has the following average quality:

| | | Temperature | Alkalinity | Conductivity | Turbidity |
|---|---|---|---|---|---|
| | pH | (° C.) | (mg/L as CaCO3) | (μS/cm) | (NTU) |
| Feed water | 5.4-5.6 | 20-22 | 6.3-6.5 | 15-17 | <0.1 |

The carbon dioxide used is commercially available as “Kohlendioxid 3.0” from PanGas AG, Dagmersellen, Switzerland. The purity is ≥99.9 Vol.-%.

### A.1 Maximal Concentration of Dissolved Calcium Carbonate in Solution

### Preparation of Calcium Carbonate Solution

The maximal concentration of dissolved calcium carbonate in RO (reverse osmosis) water was investigated by mixing CaCO3 with RO water that was pre-dosed with carbon dioxide (CO2). In CO2-acidified conditions one expects to dissolve up to 1 g of CaCO3. All the lab tests were run by batch of 1L RO water with CO2 pre-dosing at 1.5 L/min for 30 seconds through a glass nozzle placed into the RO water sample.

The limestone calcium carbonate (sample A) was used for initial testing. Initial concentrations of 0.6, 0.8, 1.0 and 1.2 g/L of CaCO3 in CO2-acidified RO water were prepared, and each of said water samples having a different CaCO3 concentration was agitated during 5 min in a closed bottle, and then was allowed to settle during 24 h. The supernatant for each water sample having a different initial CaCO3 concentration was taken and analyzed.

Table 3 shows the different results obtained for the preparation of the concentrated CaCO3 solution in CO2-acidified water using sample A at different CaCO3 concentrations in the RO (reverse osmosis) water.

TABLE 3

| Initial CaCO3 concentration | | Alkalinity |
|---|---|---|
| (g/L) | pH | (mg/L as CaCO3) |
| 0.6 | 6.13 | 405.6 |
| 0.8 | 6.22 | 438.2 |
| 1.0 | 6.31 | 466.8 |
| 1.2 | 6.52 | 387.8 |

The maximal alkalinity from the four supernatants was 466.8 mg/L as CaCO3.

This maximal alkalinity was obtained in the supernatant prepared by the addition of 1.0 g/L CaCO3 in CO2-acidified RO water. However some precipitate could still be observed at the bottom of the flask.

The marble calcium carbonate samples B and C are produced from a single production site, but have different weight median particle size. Both products were also tested for the determination of the maximal concentration of dissolved CaCO3 in CO2-acidified RO water.

This test was performed under the same conditions as for the previous tests. The initial CaCO3 concentrations used were 0.5 and 0.7 g/L for both samples B and C. The supernatants obtained after 24 h of settling were sampled and analyzed.

Table 4 shows the different results obtained for the preparation of the different concentrated CaCO3 solutions in CO2-acidified water using samples B and C at two different CaCO3 concentrations in the RO.

TABLE 4

| | Initial CaCO3 | | Alkalinity | | |
|---|---|---|---|---|---|
| | concentration | | (mg/L as | Conductivity | Turbidity |
| Samples | (g/L) | pH | CaCO3) | (μS/cm) | (NTU) |
| B | 0.5 | 5.90 | 423.1 | 1 063 | 3.64 |
| B | 0.7 | 6.01 | 529.0 | 1 449 | 3.58 |
| C | 0.5 | 5.86 | 386.3 | 898 | 1.88 |
| C | 0.7 | 5.97 | 516.4 | 1 293 | 3.37 |

As can be derived from Table 4, the maximal alkalinity of the four supernatants was obtained by the addition of 0.7 g/L CaCO3 in CO2-acidified RO water, and reached 529.0 and 516.4 mg/L as CaCO3 for the supernatants prepared from sample B and sample C, respectively. The alkalinity of the supernatant prepared from sample C with an initial concentration of 0.5 g/L was lower than expected. The reason for this is unclear, but is probably due to an imprecise dosing. Nevertheless, it fits with the lower values also observed for conductivity and turbidity. However, some precipitate could also be observed at the bottom of the flask.

### A.2 pH Change During Remineralization With Calcium Carbonate

Some remineralization tests were performed by dosing the concentrated CaCO3 solutions of the marble CaCO3 (samples B and C) into the RO water. By diluting the concentrated CaCO3 solution into the RO water, the appropriate properties for the treated water can be achieved.

The volume of concentrated CaCO3 solution added to the RO water was calculated according to its alkalinity, aiming for an alkalinity increase of 45 mg/L as CaCO3. This dosing corresponds to a dilution factor of 8-12 with respect to the initial alkalinity of the CaCO3 solutions. The RO water used for these remineralization tests had a pH value of 5.32, and the alkalinity was 6.32 mg/L as CaCO3.

After 2 minutes of mixing, sampling was performed and the conductivity and turbidity were measured, giving values between 107-118 μS/cm and 0.4-0.6 NTU, respectively. After 10 minutes, the final pH and alkalinity were also measured giving pH values of 6.3 to 6.4, and 50 to 53 mg/L as CaCO3 for the final alkalinity, respectively.

Table 5 shows the different results obtained for the remineralization of RO water by dosing a concentrated CaCO3 solution of samples B and C into the RO water (addition of 45 mg/L CaCO3).

TABLE 5

| Samples | | | | | |
|---|---|---|---|---|---|
| | Alkalinity of the | Remineralized RO water | | | |
| Name/ | CaCO3 solution | | Alkalinity^{[1]} | | |
| Initial CaCO3 | (mg/L as | | (mg/L | Conductivity^{[2]} | Turbidity^{[2]} |
| concentration | CaCO3) | pH^{[1]} | as CaCO3) | (μS/cm) | (NTU) |
| Sample B: | 423.1 | 6.34 | 51.4 | 106.7 | 0.52 |
| 0.5 g/L | | | | | |
| Sample B: | 529.0 | 6.44 | 51.6 | 111.7 | 0.39 |
| 0.7 g/L | | | | | |
| Sample C: | 386.3 | 6.43 | 53.2 | 117.5 | 0.63 |
| 0.5 g/L | | | | | |
| Sample C: | 516.4 | 6.39 | 49.7 | 106.7 | 0.48 |
| 0.7 g/L | | | | | |

^{[1]}Measured 10 minutes after the addition of the CaCO₃ solution to the RO water.
^{[2]}Measured 2 minutes after the addition of the CaCO₃ solution to the RO water.

Starting at pH 5.32 of the RO water the addition of the CaCO3 solutions induced a fast pH change up to 6.3-6.4, and within a few minutes the pH reaches a steady state. The final pH is lower than the target values between 7.0 and 8.5. It is suspected that the CO2 has been over-dosed during this test.

As a conclusion for the concentrated CaCO3 solutions in CO2-saturated RO water, the maximal values for alkalinity was in rounded figures 470 mg/L as CaCO3 for the limestone sample A, and between 520 and 530 mg/L as CaCO3 for the marble samples B and C. Remineralization with the concentrated CaCO3 solutions presented a rapid pH increase, and the stabilized pH was obtained within a few minutes. The final pH shows values between 6.3 and 6.4 for the remineralization of RO water up to the alkalinity of 50 mg/L as CaCO3, starting with RO water of a pH of 5.5, and an alkalinity of 6 mg/L as CaCO3.

### B. Pilot-Scale Examples

B.1 Pilot Remineralization Unit 1

Following the initial lab-scale remineralization tests, the pilot testing aimed at studying the process performances at a larger scale. Different types of calcium carbonate were also tested on this pilot unit. The water used was deionised water instead of reverse osmosis water. The carbon dioxide used is commercially available as “Kohlendioxid 3.0” from PanGas AG, Dagmersellen, Switzerland. The purity is ≥99.9 Vol.-%.

The pilot unit consisted in a 100 L mixing container where the CaCO3 in powder form and the deionised water were mixed at the beginning of each test. The resulting CaCO3 solution was then pumped through tube reactor at a pressure up to 2 bars. The CO2 was dosed at the start of the tube reactor at a defined flow rate, and the remineralized water flowed then through the tube reactor for allowing the complete dissolution of the CaCO3 in the water. Samples of the concentration CaCO3 solutions were taken at the end of the pipe and the pH, conductivity, turbidity were measured.

The deionised water used for these tests had the following average quality:

| | | Temperature | Conductivity |
|---|---|---|---|
| | pH | (° C.) | (μS/cm) |
| Feedwater | 4.3-4.5 | 25 | 4-7 |

### B.1.1 Maximal Concentration of Dissolved Calcium Carbonate in Solution (Sample A)

The maximal concentration of dissolved calcium carbonate in deionised water was also tested on a pilot unit in a continuous mode. The pilot tests were performed under acidic conditions by dosing carbon dioxide (CO2) into a suspension of calcium carbonate in water. According to the previous lab tests the maximal alkalinity was obtained for initial concentration between 500 and 700 mg/L of calcium carbonate in deionised water under CO2-acidified conditions. For all the pilot tests a solution having an initial concentration of calcium carbonate was mixed with the deionised water and was pumped through a tube reactor at an average flow rate of 15 L/h under a pressure of around 2 bars.

The limestone calcium carbonate (Sample A) was used for the initial pilot testing with initial concentrations of 0.5, 0.6, 0.7 g/L of CaCO3 in CO2-acidified water. The residence time in the tube reactor was around 45 minutes, and when a steady state was reached, the resulting concentrated calcium carbonate solutions were collected at the exit of the tube reactor and analyzed for pH, turbidity, conductivity and alkalinity.

Table 6 shows the different results obtained for the preparation of the concentrated CaCO3 solution in CO2-acidified water using sample A at different initial CaCO3 concentrations in the deionised water.

TABLE 6

| | Initial CaCO3 | | Alkalinity | | |
|---|---|---|---|---|---|
| Trial | concentration | | (mg/L as | Conductivity | Turbidity |
| No. | (g/L) | pH | CaCO3) | (μS/cm) | (NTU) |
| 1 | 0.5 | 5.52 | 354 | 655 | 1.73 |
| 2 | 0.5 | 5.63 | 350 | 646 | 1.35 |
| 3 | 0.6 | 5.47 | 408 | 719 | 2.44 |
| 4 | 0.7 | 5.69 | 458 | 907 | 3.03 |

As can be seen from Table 6, the maximal alkalinity (within the dose range used) when using Sample A was obtained for the addition of 0.7 g/L CaCO3 in CO2-acidified feed water and reached 458 mg/L as CaCO3, for which the turbidity was 3.03 NTU.

### B.1.2 Different Types of Calcium Carbonate

The limestone calcium carbonate (sample A) from France was compared with other calcium carbonate products for the preparation of a concentrated solution of calcium carbonate. From two different production plants, two marble calcium carbonates with different weight median particle sizes were tested, i.e. sample D and sample E were produced in the same plant in Austria, but have a weight median particle size of 3.3 and 8.0 μm, respectively. Similarly sample F and sample G were produced in the same plant in France, and have a weight median particle size of 4.4 and 10.8 μm, respectively. The main difference between the two production sites is the quality of the starting material, with a very high insoluble content of 2.0% for the first plant (samples D and E) and a low insoluble content of 0.2% for the second plant (samples F and G). The last product tested, sample H, was a precipitated calcium carbonate (PCC) product from Austria that is very pure and fine.

Table 7 summaries the different calcium carbonate products used during the remineralization tests performed at pilot-scale.

TABLE 7

| | | BET Specific surface area | |
|---|---|---|---|
| Sample | d50 (μm) | (m2/g) | HCl insoluble (%) |
| A | 3.0 | 2.7 | 0.1 |
| D | 3.3 | 3.8 | 2.0 |
| E | 8.0 | 2.2 | 2.0 |
| F | 4.4 | 3.6 | 0.2 |
| G | 10.8 | 1.7 | 0.2 |
| H | 0.6 | 19.8 | 0.1 |

The pilot tests were performed with a starting concentration for each calcium carbonate product of 0.5 g/L of CaCO3 in CO2-acidified water. The residence time in the tube reactor was the same as in the previous pilot trials, i.e. around 45 minutes with a flow rate of 15 L/h. When a steady state was reached, the resulting concentrated calcium carbonate solutions were collected at the exit of the tube reactor and analyzed for pH, turbidity, conductivity and alkalinity.

Table 8 shows the different results obtained for the preparation of the concentrated CaCO3 solutions in CO2-acidified water with different calcium carbonates for a defined CaCO3 concentration in the deionised water.

TABLE 8

| | | Initial CaCO3 | | | | |
|---|---|---|---|---|---|---|
| Trial | | concentration | | Alkalinity | Conductivity | Turbidity |
| No. | Samples | (g/L) | pH | (mg/L as CaCO3) | (μS/cm) | (NTU) |
| 5 | A | 0.5 | 5.52 | 354 | 655 | 1.73 |
| 6 | A | 0.5 | 5.63 | 350 | 646 | 1.35 |
| 7 | D | 0.5 | 5.59 | 375 | 683 | 19.00 |
| 8 | E | 0.5 | 5.34 | 192 | 397 | 16.20 |
| 9 | F | 0.5 | 5.50 | 313 | 574 | 4.34 |
| 10 | G | 0.5 | 5.24 | 192 | 360 | 2.83 |
| 11 | H | 0.5 | 5.65 | 433 | 798 | 2.53 |

As can be seen from Table 8, when sampled at the exit of the tube reactor the concentrated calcium carbonate solution with the maximal alkalinity was obtained when using the precipitated calcium carbonate (PCC) product (sample H). However, the turbidity measured for this concentrated calcium carbonate solution is not the minimal value obtained for this series of tests. In comparison with all the marble products (samples D, E, F, G), the limestone calcium carbonate (sample A) presented low turbidity values. When comparing two products of different particle sizes, for instance samples D and E, or samples F and G, it was surprisingly found that the higher the mean particle size is, the lower turbidity can be achieved. However, as expected, the lower the mean particle size is, the higher the final alkalinity and conductivity will be.

### B.1.3 Dilution to Target Remineralization Concentration

To meet the target water qualities, the concentrated calcium carbonate solution was dissolved with deionised water. Dilution factors were defined according to the initial alkalinity of the concentrated calcium carbonate with the aim of decreasing the alkalinity down to 45 mg/L as CaCO3. The final pH was adjusted to 7.8 with a 5 wt % NaOH solution, and the final turbidity was measured.

Table 9 shows the different results for the remineralized water obtained by dosing a concentrated CaCO3 solution of sample A into the deionised water (addition of 45 mg/L CaCO3).

TABLE 9

| Concentrated calcium | | | |
|---|---|---|---|
| carbonate solutions | | | |
| | Sample/ | | Turbidity of the |
| Trial | Initial CaCO3 | Initial alkalinity | remineralized water |
| No. | concentration | (mg/L as CaCO3) | (NTU) |
| 12 | Sample A: | 350 | 0.39 |
| | 0.5 g/L | | |
| 13 | Sample A: | 392 | 1.03 |
| | 0.5 g/L | | |
| 14 | Sample A: | 408 | 0.97 |
| | 0.6 g/L | | |
| 15 | Sample A: | 458 | 0.80 |
| | 0.7 g/L | | |

As can be derived from Table 9, the lowest turbidity level for this remineralization tests using a concentrated calcium carbonate was 0.39 NTU (rounded 0.4 NTU). The other trials gave higher turbidity levels between 0.8 and 1.0 (rounded values of 0.97 and 1.03) NTU.

Following a respective WHO guideline, there is most probably in future the demand to also adjust the content of soluble magnesium compounds in the final potable water to about 10 mg/L Mg.

An attempt was made to adjust the Mg content in the solution via admixing a magnesium salt to sample A of calcium carbonate before introducing the solution into the tube reactor. MgSO4 was selected as soluble Mg salt, however, it is mentioned that the final level of sulphate in the water should still remain in the allowed range (<200 ppm), especially when the treated water is used for agriculture applications. Dilution factors were also defined according to the initial alkalinity of the concentrated calcium carbonate with the aim of decreasing the alkalinity down to 45 mg/L as CaCO3. The final pH was adjusted to 7.8 with a 5 wt % NaOH solution, and the final turbidity was measured.

Table 10 shows the different results for the remineralized water obtained by dosing a concentrated CaCO3 solution of sample A and magnesium sulphate into the deionised water (addition of 45 mg/L CaCO3).

TABLE 10

| Concentrated calcium | | | |
|---|---|---|---|
| carbonate solutions | | | |
| | Initial CaCO3 | | |
| | concentration/ | | Turbidity of the final |
| Trial | initial MgSO4 | Initial alkalinity | remineralized water |
| No. | concentration | (mg/L as CaCO3) | (NTU) |
| 16 | [CaCO3] = 0.5 g/L | 367 | 0.39 |
| | [MgSO4] = 0.1 g/L | | |
| 17 | [CaCO3] = 0.5 g/L | 329 | 0.37 |
| | [MgSO4] = 0.1 g/L | | |

Some samples of remineralized water were sent to a water quality control laboratory in order to evaluate all drinking water properties. For instance, the remineralized water obtained by using only calcium carbonate and that showed the lowest turbidity level was obtained from Trials No. 12 and No. 15. The remineralized water obtained by using a mixture of calcium carbonate and magnesium sulphate and that showed the lowest turbidity level was obtained from Trial No. 17. These three samples were sent to the Carinthian Institute for Food Analysis and Quality Control, Austria, for analysis, and the water samples were approved by the institute to be in compliance with the strict Austrian guidelines for drinking water quality and with the WHO guidelines for soluble magnesium.

Table 11 shows the drinking water quality for the remineralized water obtained by dosing a concentrated CaCO3 solution of sample A into the deionised water (addition of 45 mg/L CaCO3).

TABLE 11

| | Remineralized water samples | | |
|---|---|---|---|
| Drinking water | CaCO3 only | | CaCO3/MgSO4 |
| properties | Trial No. 12 | Trial No. 15 | Trial No. 17 |
| Calcium | 19.0 | 21.2 | 21.2 |
| (mg/L) | | | |
| Magnesium | — | — | 13.4 |
| (mg/L) | | | |
| Total hardness | 47.2 | 52.7 | 109.7 |
| (mg/L as CaCO3) | | | |
| pH | 7.9 | 7.7 | 7.7 |
| Saturation index | 0.1 | −0.3 | 0 |
| Conductivity | 446 | 216 | 540 |
| (μS/cm) | | | |
| Turbidity | 0.4 | 0.3 | 0.33 |
| (NTU) | | | |

### B.2 Pilot Remineralization Unit 2

Following the initial pilot remineralization tests a new series of trials at pilot scale were performed on another remineralization unit able to work at a pressure range from 2-7 bars, a RO water flow rates between 300 and 400 L/h, and a CO2 dosing between 1.1 and 5.5 L/min. The carbon dioxide used is commercially available as “Kohlendioxid 3.0” from PanGas AG, Dagmersellen, Switzerland. The purity is ≥99.9 Vol.-%.

The pilot unit consisted in a 60 L mixing container where the CaCO3 in powder form and the RO water were introduced at defined times (i.e. more than once). The resulting CaCO3 solution was then pumped through a mixer where the CO2 was dosed at a defined flow rate, and the concentrated CaCO3 solution was passed through a pipe for allowing the complete dissolution of the CaCO3 in the water. The residence time in the tube reactor was around 45 minutes, and when a steady state was reached, the resulting concentrated calcium carbonate solutions were collected at the exit of the tube reactor and analyzed for pH, turbidity, conductivity and alkalinity.

### B.2.1 Different Working Pressures

Different working pressures were tested on the above described remineralization pilot unit in order to study the effect of pressure on the dissolution of calcium carbonate in RO water under acidic conditions with carbon dioxide (CO2). According to the results from the former pilot tests an initial concentration of 500 mg/L of calcium carbonate in RO water was prepared, and the resulting solution was dosed with some excess CO2. The pilot tests performed at different working pressure had a flow rate of 300 L/h, and the pressure was varied between 2 and 7 bars. The calcium carbonate used for these pilot tests was a limestone from France (Sample A).

Table 12 shows the different results obtained for the preparation of the concentrated CaCO3 solution in CO2-acidified water using sample A having a concentration of 0.5 g/L of CaCO3 in the RO water at different pressures and for a CO2 flow rate of 3.3 L/min.

TABLE 12

| Trial | Pressure | Temperature | | Conductivity | Turbidity |
|---|---|---|---|---|---|
| No. | (bar) | (° C.) | pH | (μS/cm) | (NTU) |
| 18 | 2.0 | 27 | 6.51 | 660 | 20 |
| 19 | 2.0 | 25 | 6.66 | 660 | 23 |
| 20 | 4.0 | 28 | 6.55 | 700 | N/A |
| 21 | 5.5 | 29 | N/A | 680 | 40 |
| 22 | 5.5 | 28 | 6.84 | 670 | 34 |
| 23 | 6.0 | 30 | 6.53 | 680 | 28 |
| 24 | 7.0 | 29 | 6.91 | 660 | 30 |

These pilot tests showed that under these testing conditions a higher pressure does not improve the dissolution of CaCO3 resulting in higher turbidity level for the higher pressures tested. One of the consequences of using higher pressure is the temperature increase of the CaCO3 solution which is due to the pumps. Therefore, the remineralized water exiting the pilot unit is hotter, which may have an impact on the solubility of the CO2 in the water. In other words, the higher the temperature of the water, the lower the CO2 dissolution in the water. As a consequence of the below reaction scheme:

CaCO3+CO2+H2O→Ca2++2HCO3—

there is less dissolved CaCO3 in the solution, which in turn leads to a higher turbidity level due to the amount of undissolved CaCO3.

### B.2.2 Different CO2 Flowrates

It is highly suspected that the dosing of CO2 will have a significant impact on the dissolution rate of the CaCO3 in the RO water. Therefore, different flow rates of CO2 were tested for the preparation of the concentrated solution of CaCO3. All the tests were performed using the same protocol as described for the previous tests for a defined pressure, but with different CO2 flow rates.

Table 13 shows the different results obtained for the preparation of the concentrated CaCO3 solution in CO2-acidified water using sample A having a concentration of 0.5 g/L of CaCO3 in the RO water, at a pressure of 5.5 bars using different CO2 flow rates.

TABLE 13

| Trial | CO2 flow rate | Temperature | Conductivity | Turbidity |
|---|---|---|---|---|
| No. | (L/min) | (° C.) | (μS/cm) | (NTU) |
| 25 | 1.1 | 29 | 330 | 138 |
| 26 | 3.3 | 29 | 680 | 40 |
| 27 | 5.5 | 29 | 720 | 7 |

It can be seen from the results presented in Table 13 that under the tested conditions the solubility of the CaCO3 in the RO water can be improved when increasing the CO2 flow rate. This can be derived from the increase of the conductivity and a decrease of the turbidity at the exit of the reaction pipe, when increasing the CO2 flow rate.

### B.2.3 Residence Time

The residence time allocated for the dissolution of CaCO3 to take place was also studied. In this regard, the pilot tests were performed using either one single or two pipes connected one after the other. This setting allowed to double the residence time from approximately 45 minutes for one pipe to approximately 90 minutes for two connected pipes, and therefore to study the impact of the residence time on the resulting turbidity and conductivity.

Table 14 shows the different results obtained for the preparation of the concentrated CaCO3 solution in CO2-acidified water using sample A having a concentration of 0.5 g/L of CaCO3 in the RO water at a defined CO2 flow rate and pressure for different residence time.

TABLE 14

| | | CO2 flow | Approximated | | | |
|---|---|---|---|---|---|---|
| Trial | Pressure | rate | residence time | Temperature | Conductivity | Turbidity |
| No. | (bar) | (L/min) | (min) | (° C.) | (μS/cm) | (NTU) |
| 28 | 2.0 | 3.3 | 45 | 27 | 670 | 20 |
| 29 | 2.5 | 3.3 | 90 | 26 | 700 | 4 |
| 30 | 5.5 | 1.1 | 45 | 29 | 330 | 138 |
| 31 | 6.0 | 1.1 | 90 | 29 | 460 | 85 |

The two sets of tests presented in Table 14 show clearly that the residence time has a direct effect on the dissolution of CaCO3 in the RO water for both tested conditions, i.e. Trials No. 28 and No. 29, and Trials No. 30 and No. 31. It can clearly be seen that the longer the residence time, the lower the turbidity will be, and respectively the higher the conductivity will be.

### C. Additional Examples

### Marble/Limestone

The following examples present the preparation of concentrated solutions of calcium hydrogen carbonate in reverse osmosis (RO) water by the means of CO2 dosing into a suspension of calcium carbonate, and the filtration of the resulting suspension through an ultrafiltration membrane in order to remove the remaining insolubles.

Two calcium carbonate products were selected according to their physical and chemical properties, e.g. carbonate rocks, mean particle size, insoluble content, and specific surface area and were compared to one another with respect with the final turbidity and conductivity of the filtered concentrated calcium hydrogen carbonate solutions.

The following Table 15 summaries the different calcium carbonate products used during the pilot trials for the preparation of calcium hydrogen carbonate solutions.

TABLE 15

| | Calcium carbonate | Surface area | d50 | HCl insoluble |
|---|---|---|---|---|
| Samples^{[1]} | rock | (m2/g) | (μm) | (%) |
| A | Limestone | 2.7 | 3.0 | 0.1 |
| B | Marble | 4.4 | 2.5 | 3 |

^{[1]}It has to be noted that all of the above listed calcium carbonates are commercially available from the company Omya, Switzerland.

The RO water used for these tests has the following average quality:

| | | Turbidity | Temperature | Conductivity |
|---|---|---|---|---|
| | pH | (NTU) | (° C.) | (μS/cm) |
| Feedwater | 5.3-5.6 | 0.2-0.6 | 24-25 | 14-18 |

### C.1 Pilot-Scale Examples

A series of trials at pilot-scale were performed in a rector system under the following work conditions:
Pressure: ˜2.5 bars, flow rate: ˜300 L/h, and CO2 dosing: of 3.3 L/min.

The carbon dioxide used is commercially available as “Kohlendioxid 3.0” from PanGas AG, Dagmersellen, Switzerland. The purity is ≥99.9 Vol.-%.

The reactor system consisted in a 60 L mixing tank where the CaCO3 in powder form and the RO water were introduced at defined times (i.e. more than once) in order to have an initial concentration of the calcium carbonate of 500-1000 mg/L 0.05-0.1 wt %). The starting CaCO3 suspension was then pumped through a mixer where the CO2 was dosed at a defined flow rate for allowing the dissolution of the calcium carbonate into the RO water according to the following reaction:

CaCO3(s)+CO2(aq)+H2O→Ca(HCO3)2(aq)

The resulting suspension was passed through a pipe for the complete dissolution of the CaCO3 in the water. The residence time in the pipe was around 40 minutes, and when a steady state was reached, the resulting suspension was collected at the exit of the pipe and analyzed for conductivity and turbidity.

The resulting suspension was then pumped through an ultrafiltration membrane, of the type Inge dizzer P 2514-0.5, for the removal of the insoluble material. Two filtration modes, cross-flow and dead-end, were tested: the former mode consisting in ⅔ of the flow rate being recirculated and ⅓ of the flow rate going through the membrane, and the latter mode consisting in having the complete flow rate going through the ultrafiltration membrane.

The filtered calcium hydrogen carbonate solutions were analyzed for conductivity and turbidity as well, and compared to the initial feed calcium carbonate solutions and the unfiltered resulting suspensions that were recirculated back in the tank.

### C.1.1 Trials With Very Pure Calcium Carbonate

The feed (or starting) CaCO3 solutions were prepared with sample A at different initial concentrations of calcium carbonate in reverse osmosis water, but also with different stoichiometric excess of CO2, and residence time.

Table 16 shows the working conditions in cross-flow mode for the preparation of the calcium hydrogen carbonate solution (sample A) in RO water.

TABLE 16

| | Preparation of the feed CaCO3 | | |
|---|---|---|---|
| | suspension (sample A) | | |
| Trials | Initial CaCO3 | Residence time | CO2 stoichiometric |
| No. | concentration (mg/L) | (min) | excess (x-fold) |
| 1 | 500 | 80 | 6 |
| 2 | 500 | 40 | 6 |
| 3 | 1000 | 40 | 3 |

Table 17 shows the different results obtained for the feed CaCO3 suspensions (sample A) and the resulting unfiltered suspensions and the filtered calcium hydrogen carbonate solutions.

TABLE 17

| | | | | | Filtered | |
|---|---|---|---|---|---|---|
| | | | Unfiltered resulting | | calcium hydrogen | |
| | Feed CaCO3 suspension | | suspension (⅔) | | carbonate solution (⅓) | |
| Trials | Conductivity | Turbidity | Conductivity | Turbidity | Conductivity | Turbidity |
| No. | (μS/cm) | (NTU) | (μS/cm) | (NTU) | (μS/cm) | (NTU) |
| 1 | 690-720 | 3.8-5.4 | 710 | <2.9 | 695 | <0.8 |
| 2 | 670-710 | 27-32 | 700-720 | <18 | 695 | <0.8 |
| 3 | 870-890 | 200-240 | 870-880 | <170 | 880 | <0.8 |

The residence time used for the preparation of the feed CaCO3 suspension did not affect the conductivity and the turbidity of the filtered calcium hydrogen carbonate solution (trials 1 and 2). This means that shorter residence time can also be used for the preparation of the calcium hydrogen carbonate solution when ultrafiltration is used for the final removal of the insoluble part. The unfiltered resulting suspension that was recirculated to the tank showed a significantly lower turbidity level than the feed CaCO3 suspension, and kept decreasing as the recirculation went on.

Increasing the initial concentration of the feed CaCO3 suspension presented a higher conductivity level for the filtered calcium hydrogen carbonate solution; even with less CO2 excess (trial 3). The extreme high turbidity level of the feed CaCO3 suspension for this trial, 200-240 NTU, did not affect the resulting final turbidity after ultrafiltration e.g. <0.8 NTU.

### C.1.2 Trials With Calcium Carbonate Containing High Insoluble Content

The feed CaCO3 suspensions were prepared with sample B at different initial concentrations of calcium carbonate in reverse osmosis water, with a residence time of 40 minutes, with a 6-and 3-fold stoichiometric excess of CO2 and either cross-flow or dead-end as filtration modes.

Table 18 shows the working conditions for the preparation of the calcium hydrogen carbonate solution in RO water using sample B.

TABLE 18

| | Preparation of the feed CaCO3 | | | |
|---|---|---|---|---|
| | suspension (sample B) | | | |
| | Initial CaCO3 | | CO2 | |
| Trials | concentration | Residence time | stoechiometric | Filtration mode |
| No. | (mg/L) | (min) | excess (x-fold) | (filtered ratio) |
| 4 | 500 | 40 | 6 | cross-flow |
| | | | | (33%) |
| 5 | 1000 | 40 | 3 | dead-end |
| | | | | (100%) |

Table 19 shows the different results obtained for the feed CaCO3 suspensions prepared with sample B and the resulting suspensions as well as of the filtered calcium hydrogen carbonate solutions.

TABLE 19

| | |
|---|---|
| | Filtered calcium |
| Feed CaCO3 | hydrogen carbonate |
| suspension | solution |

| Trials | Conductivity | Turbidity | Conductivity | Turbidity |
|---|---|---|---|---|
| No. | (μS/cm) | (NTU) | (μS/cm) | (NTU) |
| 4 | 680-700 | 52-61 | 705 | <0.7 |
| 5 | 870-880 | 210-230 | 870 | <0.7 |

When comparing trials 2 and 4, the high insoluble content of sample B obviously has only an impact on the turbidity of the feed CaCO3 suspension, namely a turbidity of 27-32 NTU for the feed CaCO3 suspension prepared with sample A and a turbidity of 52-61 NTU for the feed CaCO3 suspension prepared with sample B. However, the final conductivity and turbidity of the filtered calcium hydrogen carbonate solutions are similar, with a maximal turbidity level of 0.7-0.8 NTU and conductivity of 695-705 μS/cm for both filtered calcium hydrogen carbonate solutions.

When comparing trials 3 and 5, it is apparent that the high insoluble content of sample B does not have an impact on either one of the turbidity and the conductivity of both feed CaCO3 suspensions, namely with a turbidity level around 200-240 NTU and a conductivity level of 870-890 μS/cm. This is because the non-dissolved CaCO3 present in both feed suspensions is so large that it probably induces nearly all the turbidity, and the insoluble part coming from the raw material has no impact on the turbidity under these conditions.

The filtered calcium hydrogen carbonate solutions presented also similar final conductivity and turbidity levels, with a maximal turbidity level of 0.7-0.8 NTU and a conductivity of 870-880 0/cm. These results confirm that the insoluble content of the raw material will not affect the final quality of the calcium hydrogen carbonate solution when ultrafiltration is used.

Finally the dead-end filtration mode did not show any significant changes during the tested period for trial 5 and gave similar results compared to the trials performed using the cross-flow filtration mode.

1. Process for remineralization of water comprising the steps of:
a) providing feed water,
b) providing an aqueous solution of calcium carbonate, wherein the aqueous solution of calcium carbonate comprises dissolved calcium carbonate and reaction species thereof, and
c) combining the feed water of step a) and the aqueous calcium carbonate solution of step b).

2. The process of claim 1, wherein the concentration of calcium carbonate in the solution is from 0.1 to 1 g/L, preferably from 0.3 to 0.8 g/L, and more preferably from 0.5 to 0.7 g/L, based on the total weight of the solution.

3. The process of claim 1, wherein the calcium carbonate used for the preparation of the aqueous solution of calcium carbonate of step b) has a weight median particle size d50 from 0.1 to 100 μm, from 0.5 to 50 μm, from 1 to 15 μm, preferably from 2 to 10 μm, most preferably 3 to 5 μm, or the calcium carbonate has a weight median particle size d50 from 1 to 50 μm, from 2 to 20 μm, preferably from 5 to 15 μm, and most preferably from 8 to 12 μm.

4. The process of claim 1, wherein the aqueous solution of calcium carbonate of step b) has been prepared by one of the following steps:
A) preparing an aqueous suspension of calcium carbonate in a first step, and introducing either: (i) a carbon dioxide generating compound, (ii) a carbon dioxide generating compound and an acid, or (iii) an acid to an aqueous suspension of calcium carbonate in a second step, or introducing in a first step either: (i) a carbon dioxide generating compound, (ii) a carbon dioxide generating compound and an acid, or (iii) an acid in the water to be used for the preparation of the solution of calcium carbonate, and then introducing calcium carbonate, either in dry form or as a suspension in a second step in the water, or introducing a suspension of calcium carbonate and either: (i) a carbon dioxide generating compound, (ii) a carbon dioxide generating compound and an acid, or (iii) an acid simultaneously.

5. The process of claim 1, wherein the calcium carbonate ground calcium carbonate, modified calcium carbonate, or precipitated calcium carbonate, or mixtures thereof.

6. The process of claim 1, wherein the obtained remineralized water has a calcium concentration as calcium carbonate from 15 to 200 mg/L, preferably from 30 to 150 mg/L, and most preferably from 100 to 125 mg/L, or from 15 to 100 mg/L, preferably from 20 to 80 mg/L, and most preferably from 40 to 60 mg/L.

7. The process of claim 1, wherein the solution of step b) comprises further minerals containing magnesium, potassium or sodium, preferably magnesium carbonate, calcium magnesium carbonate, e.g. dolomitic limestone, calcareous dolomite or half burnt dolomite, magnesium oxide such as burnt dolomite, magnesium sulfate, potassium hydrogen carbonate, or sodium hydrogen carbonate.

8. The process of claim 7, wherein the obtained remineralized water has a magnesium concentration from 5 to 25 mg/L, preferably from 5 to 15 mg/L, and most preferred from 8 to 12 mg/L.

9. The process of claim 1, wherein the remineralized water has a turbidity value of lower than 5.0 NTU, lower than 1.0 NTU, lower than 0.5 NTU, or lower than 0.3 NTU.

10. The process of claim 1, wherein the remineralized water has a Langelier Saturation Index from −1 to 2, preferably from −0.5 to 0.5, most preferred from −0.2 to 0.2.

11. The process of claim 1, wherein the remineralized water has a Silt Density Index SDI 15 below 5, preferably below 4, and most preferred below 3.

12. The process of claim 1, wherein the remineralized water has a Membrane Fouling Index MFI0.45 below 4, preferably below 2.5, most preferred below 2.

13. The process of claim 1, wherein the feed water is desalinated seawater, brackish water or brine, treated wastewater or natural water such as ground water, surface water or rainfall.

14. The process according to claim 1, wherein the remineralized water is blended with feed water.

15. The process according to claim 1, wherein the process further comprises a particle removal step.

16. The process of claim 1, wherein the process further comprises the steps of:
d) measuring a parameter value of the remineralized water, wherein the parameter is selected from the group comprising alkalinity, total hardness, conductivity, calcium concentration, pH, CO2 concentration, total dissolved solids, and turbidity of the remineralized water, e) comparing the measured parameter value with a predetermined parameter value, and
f) providing the amount of injected solution of calcium carbonate on the basis of the difference between the measured and the predetermined parameter value.

17. The process of claim 16, wherein the predetermined parameter value is a pH value, wherein the pH value is from 5.5 to 9, preferably from 7 to 8.5.

18. Use of a solution of calcium carbonate for remineralization of water.

19. The use of claim 18, wherein the remineralized water is selected from drinking water, recreation water such as water for swimming pools, industrial water for process applications, irrigation water, or water for aquifer or well recharge.
